(19) United States
(12) Patent Application Publication
(10) Pub. No.: US 2014/0089165 A1
(43) Pub. Date: Mar. 27, 2014

(54) METHOD AND SYSTEM OF APPROVING FINANCING FOR A SALE

(71) Applicant: David J. Homoki, El Cajon, CA (US)

(72) Inventor: David J. Homoki, El Cajon, CA (US)

(21) Appl. No.: 13/624,947

(22) Filed: Sep. 23, 2012

(51) Int. Cl. G06Q 40/02

(52) U.S. Cl. 705/38

(57) ABSTRACT

Approving financing for a sale. At least some of the illustrative embodiments are methods including: receiving a request to approve a customer for a sale to be paid for with multiple payments over a sales period; collecting financial information of the customer; calculating a value indicative of willingness-to-pay, the calculating by a computer system, where the value indicative of willingness-to-pay is calculated based on a proposed price of the sale and a value indicative of modified income of the customer; and then determining whether the customer is approved for the sale based on the value indicative of willingness-to-pay, the value indicative of modified income of the customer, and the financial information of the customer; and if the customer is approved determining terms of the sale.

### BACKGROUND

A consumer wishing to purchase an item, but not having the funds to make the full payment outright, may contract with a merchant to make payments for the item over a sales period. However, if a customer takes possession of the product at the beginning of the sales period, he may stop making payments towards the end of the period, and thus the merchant risks not being paid in full. Therefore, any method in which the merchant can be more assured of being paid would be advantageous.

### BRIEF DESCRIPTION OF THE DRAWINGS

For a detailed description of exemplary embodiments, reference will now be made to the accompanying drawings in which:

FIG. 1 shows a screenshot of a portion of a webpage in accordance with at least some embodiments;

FIG. 2 shows a bar graph in accordance with at least some embodiments;

FIG. 3 shows a line graph in accordance with at least some embodiments;

FIG. 4 shows a bar graph in accordance with at least some embodiments;

FIG. 5 shows a line graph in accordance with at least some embodiments;

FIG. 6 shows, in block diagram form, a computer system in accordance with at least some embodiments; and

FIG. 7 shows, in block diagram form, a method in accordance with at least some embodiments.

### NOTATION AND NOMENCLATURE

Certain terms are used throughout the following description and claims to refer to particular system components. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

“Return” shall mean an electronic debit or a physical check presented to a customer's bank and subsequently rejected for payment.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various embodiments are directed to receiving a request to approve a customer for a purchase of an item to be paid for over a predetermined sales period. In one embodiment, the request for approval may come from a customer to a merchant, while in another embodiment the request may be from the merchant to a third party financer. The merchant or the third party financer collects financial information from the customer, determines whether customer is initially approved, and if so, using a computer system, a payment plan over a predetermined sales period is determined. The specifics of the payment plan are determined from the customer's financial information, and current and historic economic numbers from the customer's region of residence, as well as the nation as a whole. The specification first turns to receiving financial information from the customer and determining an initial approval for the sale.

A customer wishing to purchase an item, but lacking the funds to make the purchase outright, may contract with a merchant to make payments for the item over a sales period. Before any calculations are made to determine a payment plan for a customer, the customer is first approved for the sale. At the onset, the customer provides at least one bank statement for the month preceding the beginning of the desired sales period. While the customer may be asked to provide the previous month's bank statement, any number of current or past bank statements may be requested. The bank statements are analyzed to consider the number of times, if any, the customer has overdrawn their account (e.g., indications of non-sufficient funds). If there are any present instances of non-sufficient funds, the customer will be disqualified for the sale, as a non-sufficient funds indication would indicated the person is unable to sustain their current spending habits. Additionally, previous non-sufficient fund indications on the customer's bank statement may be considered in determining whether the customer is approved for financing. The bank statement is treated like a balance sheet snapshot of the customer's spending habits and potential ability for carrying more debt. For example, in order to determine a customer's potential ability to make payments throughout a month, the customer's beginning, ending, and running balances may be considered in the approval process. References on a bank statement to other debt obligations and/or the lack of references to other debt obligations may also be taken into consideration. Furthermore, references in the bank statement to credit card payments, or other similar payments, are used in considering what other financed debt the customer may or may not have. If there are few or no indications of other debt, the beginning, ending, and running balances may alone provide an indicator of a customer's ability to make payments. For example, if the bank statement balances are low, that may indicate the customer has financial hardships, or has otherwise previously defaulted on a debt. On the other hand, if the balances are high and/or there are no debt payments, that may indicate the customer refrains from using credit or from overspending on purchases.

In addition to considering the customer's bank statements, the approval process may also include a consideration of at least one of the customer's pay stubs. For example, the number of hours the customer has worked may be taken into consideration. In particular, in one embodiment, if the customer worked less than 32 hours per week, that may be considered negatively. In another embodiment, a customer working multiple jobs, and the total number of hours worked in the week exceeds may indicate the possibility customer will leave at least one of the jobs in the near future, and thus may also be considered negatively.

Moreover, when considering a customer's bank statement, the age of the bank account may be taken into account. For example, in one embodiment, a bank account open for less than 90 days may indicate the customer has opened a new account in order to present a more positive front, and thus the account details may not present an accurate indication of the customer's financial situation. In contrast, an account that has been open for over 90 days may be more likely to provide a more accurate indication of the customer's financial situation.

While a variety of financial data has been discussed, other data related to a customer's income source and debt obligations may be considered in order to determine a customer's propensity for living beyond their means.

After the initial approval process, software running on a computer system calculates information related to the customer and calculates a payment plan that will result in a lower probability of a return or non-payment to the merchant. In one embodiment, the merchant may input the information from the customer onto an online form (such as ARC 90 software) in order to establish the payment plan for the customer. The specification next turns to a description of gathering information related to the customer and the item.

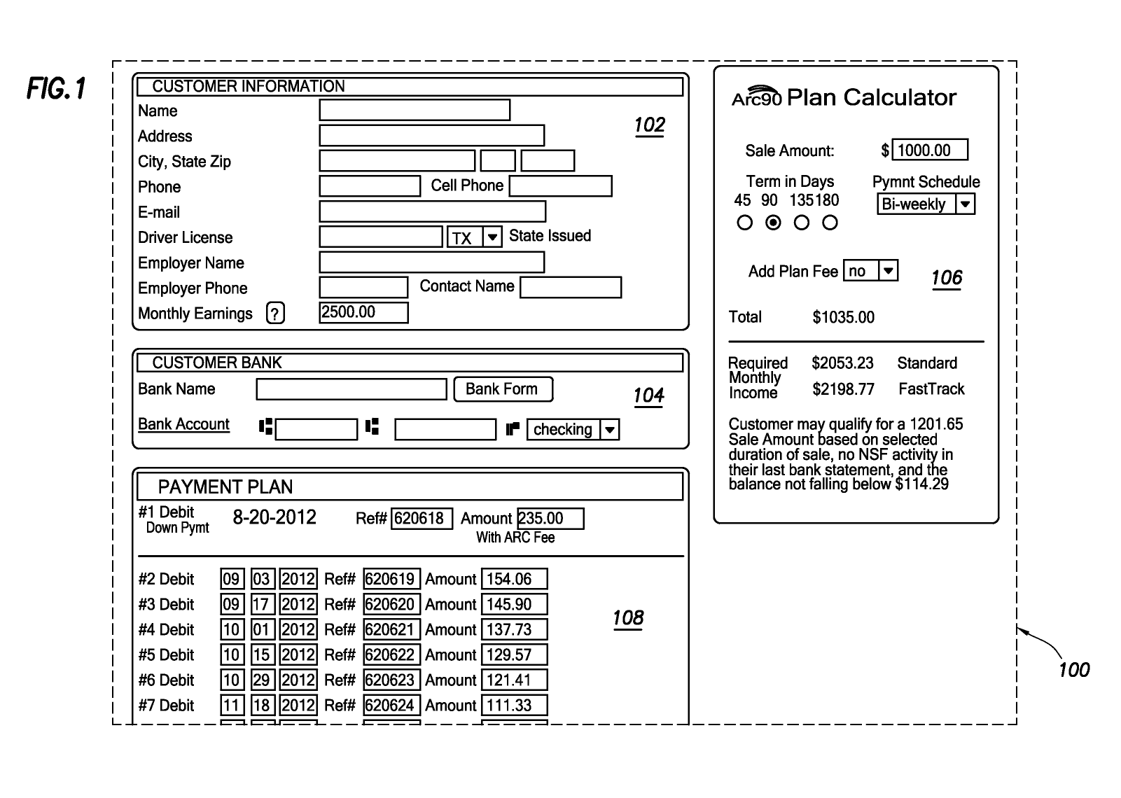

FIG. 1 shows a portion of a screenshot of software running on a computer system. In particular, FIG. 1 shows a portion of a web-form 100, the information from which will be used to calculate a payment plan for a customer. The merchant enters information related to the customer into both the customer information box 102 and the customer bank box 104. In one embodiment, the sale amount and sales period are entered into block 106, where the sales price is calculated based on the gross monthly income of the customer (discussed later) and a sales period selected. In one embodiment, the sales period may be 45-days, 90-days, 135-days, or 180-days; however, the number of days is not limited to only these options and may be any number of days, weeks, or months. In addition to the sales period, the payment schedule is selected. In one embodiment, the payment schedule may be weekly. In another embodiment, the payment schedule may be bi-weekly. In yet another embodiment, the payment schedule may be monthly.

Based on information including the sale amount, sales period, and the payment schedule, a specific payment plan is calculated for the customer. Block 108 shows a portion of an example payment plan after it has been calculated for a customer. In particular, the payment plan is calculated with decreasing payment values over the sales period. This decreasing amount of each payment is calculated to reduce the percentage of returns experienced by the merchant.

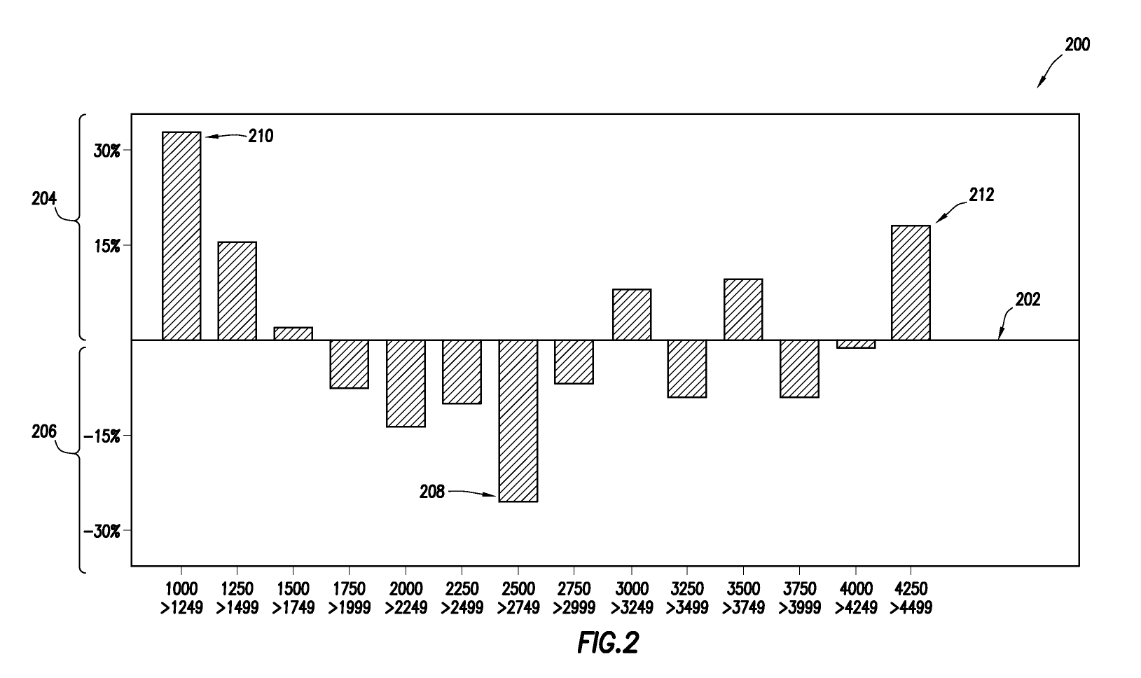

The specification now turns to an overview of how a percentage of returns are considered when calculating a payment plan. Turning to FIG. 2, FIG. 2 shows a bar graph in accordance with some embodiments. In particular, FIG. 2 shows a bar graph 200 representing example percentage of returns collected across a plurality of income ranges as compared to the average percentage of returns of all income ranges. The x-axis 202 represents a percentage of returns of 0%. In other words, a point plotted on the x-axis indicates that, the ratio of returns versus the number of sales for that specific income range is equivalent to the ratio of returns versus the number of sales for all of the income ranges combined. Thus, at a point of 0%, the specific income range experiences no more or no less returns versus sales than the average of income ranges as a whole. A percentage of returns in the positive percentage section 204 indicates a higher than average percentage of returns. In other words, the likelihood of the customer not making a payment is higher for positive percentages. In contrast, a percentage of returns in the negative percentage section 206 indicates a lower than average percentage of returns. In other words, the likelihood of a customer not making a payment is lower for negative percentages. In FIG. 2, for example, income range 208 falls between $2500 a month and $2749 a month and has the lowest percentage of returns of the income ranges, with a percentage of returns of roughly −28%. In contrast, income range 212 (or $4300 a month and greater) has a high percentage of returns of +17%. In this example embodiment, the graph shows that the lower income ranges and the higher income ranges are more likely to result in greater percentage of returns. In contrast, income ranges towards the middle of all incomes appear to have the lowest percentage of returns.

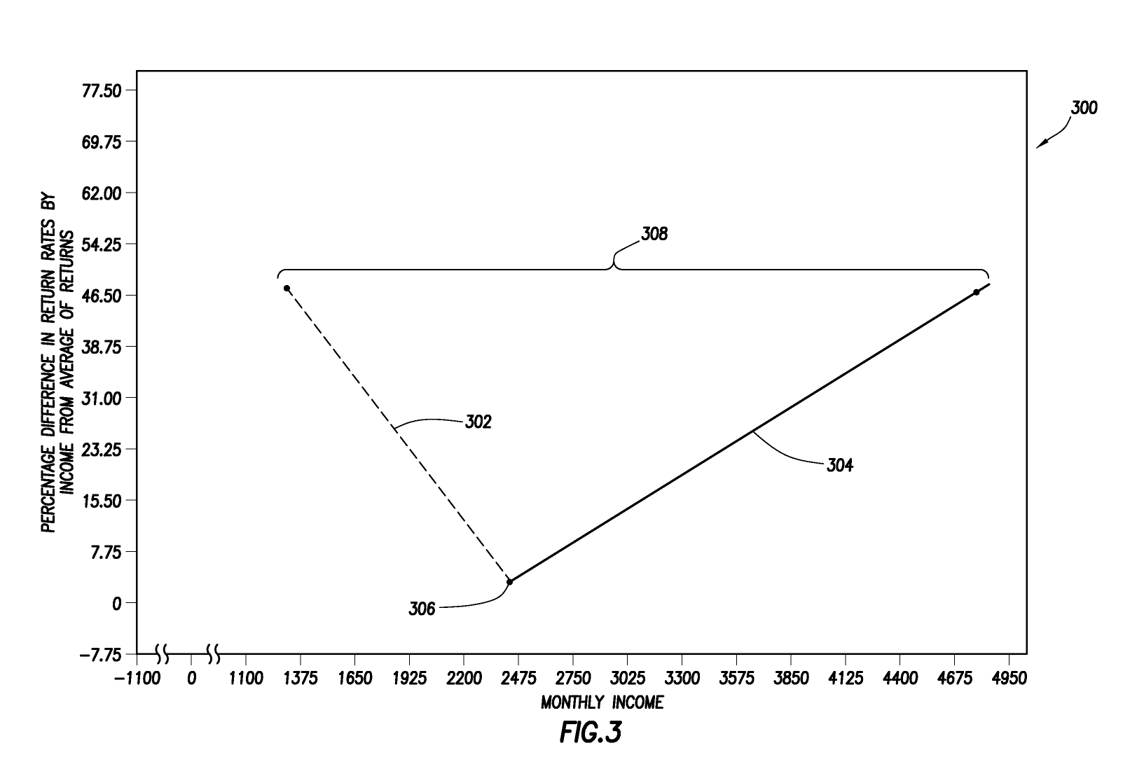

Turning now to FIG. 3, FIG. 3 shows a linear regression graph 300 representing the data obtained from FIG. 2. In particular, the linear regression graph 308, in its entirety, is created using two formulas: one formula to describe the income-versus-percentage of returns for incomes that fall below the lowest percentage of returns income level (i.e., in FIG. 2, income level 208), and another formula to describe the income-versus-percentage of returns for incomes that fall above example income level 208. For simplification purposes, the income range 208 will be considered the income level with the lowest percentage of returns; however, the income ranges and percentage of returns vary over time and any income range or returns rates may be considered and calculated.

In one embodiment, for a customer with an income range below example income range 208 (i.e., $2499 and less), the dashed line 302 is expressed by equation (1) below:

Y=−0.0368X+95.2011 (1)

In the same example embodiment, for sales made to a customer with an income range above income range 208 (i.e., $2749 and more), the solid line 304 is expressed by equation (2) below:

Y=0.0167X+(−34.1847) (2)

Calculating the linear regression line for monthly income versus percentage of returns results in a minimum intersection point 306. Point 306 is the monthly income at which the lowest percentage of returns is likely to occur. While in this example, the monthly income level that yields the lowest percentage of returns is roughly $2475, both the percentage of returns and the income levels will change with changes in the economy. Thus, the income level yielding the lowest percentage of returns may be higher or lower depending on outside factors. Regardless of what income level point 306 represents, the income level corresponding to point 306 will be used in future calculation until a new point is indicated by the data.

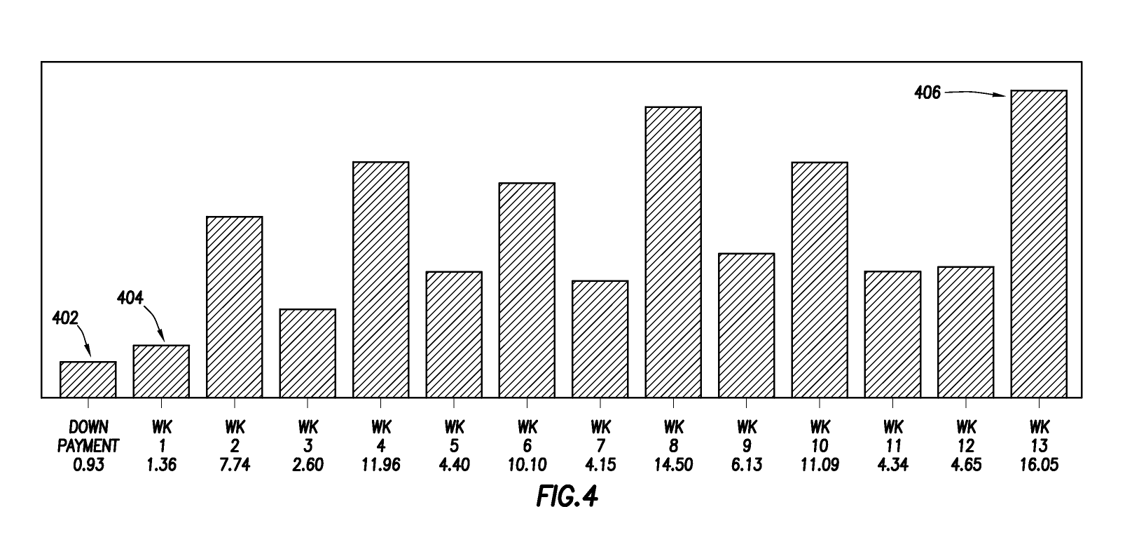

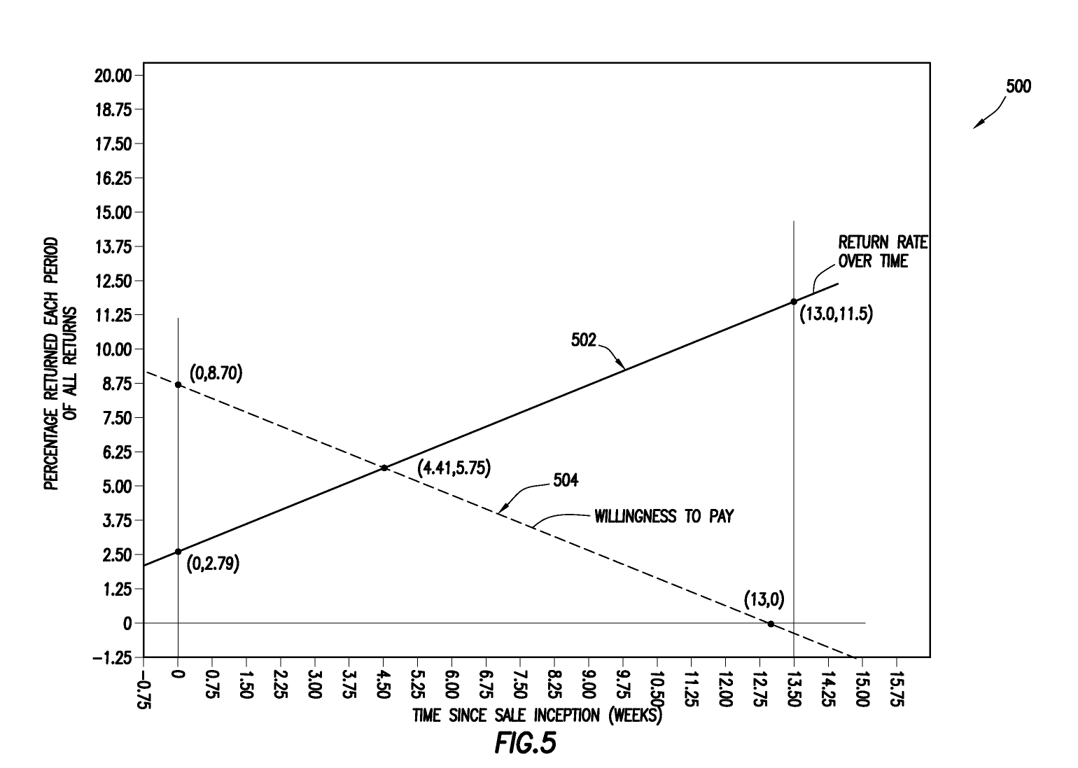

Turning now to FIG. 4, FIG. 4 illustrates an example graph of the percentage of returns observed each week over an example sales period of 90-days. The percentage of returns shown in FIG. 4 may have been observed over a sales period, for a plurality of items purchased, either for one individual merchant or multiple merchants, and then graphed to provide an overall analysis of the trend of returns over a sales period. In particular, FIG. 4 shows a rising trend of the percentage of returns over the 90-day period, shown in week blocks, as payments may be made at the beginning or end of each week period. The lowest percentage of returns, 0.93%, is seen right after the initial down payment 402 is made. After week 1, the percentage of returns has increased to 1.36%. Even if the rates drop and rise throughout the time, the overall trend of returns over the sales period increases through week 13, where the percentage of returns is 16.05%. While FIG. 4 shows a graph for 90-days, the same trend may be seen over any sales period, such as 120-days or 180-days. Still further considering the percentage of returns over the 90-day sales period, a further analysis can be conducted by creating a line graph depicting the percentage of returns over the sale period, as shown in FIG. 5.

Turning now to FIG. 5, FIG. 5 shows a graphical representation 500 of the total percentage of sales that are returns over an example 90-day sales period, as well as the customer's willingness to pay over the same 90-day sales period. In particular, the two lines shown in FIG. 5 are linear regressions calculated from the data obtained in FIG. 4.

The percentage of returns trend line 502, shown as a solid line, is expressed by the equation (3) below:

Y=0.670X+2.79 (3)

As the sales period progresses throughout the weeks, the percentage of returns increases. In particular, in this example, the percentage of returns at the inception of the sale is 2.79%; however, by week 13, the percentage of returns has grown to 11.5%. This increase indicates that that a customer's desire to continue paying over time for an item already in possession declines over time.

Reversing the percentage of returns line 502 gives a willingness-to-pay line 504 (shown as a dashed line), where the willingness-to-pay line 504 is an indicator of how willing the customer is to continue making payments on the item as the sales period progresses. In this example, setting the 13th week (i.e., the last week of the sales period) percentage of percentage of returns value to 0 indicates that by the end of the sale period the customer has zero willingness to make a payment. Each point along the willingness-to-pay line 504 thus provides the expected percentage change of there being a return at any given week throughout the sales period. The willingness-to-pay slope may be updated on a daily basis from the returns reports and the sales reported each day, and thus the slope may fluctuate. The willingness-to-pay data will be used in later calculations.

The specification now turns to determining an appropriate payment plan for a customer by using the data observed and calculated in FIGS. 2 through 5, as well as additional data and information provided by the customer. The first step in determining an appropriate payment plan is to determine what the permitted sale amount should be for a customer with a specific gross monthly income. The specification thus turns to example calculations used in making a permitted sale amount determination by calculating an adjusted income for the customer.

The customer's adjusted income level is calculated, in part, by taking into consideration economic numbers in the state in which the customer resides, as well as economic numbers of the nation as a whole Both the ability to earn a certain level of income, as well as the cost of living, varies from state to state. Using data obtained from public agencies, such as the Bureau of Economic Analysis and the Census Bureau, the customer's income may be adjusted using equation (4) below:

Ai=(CLc/CLn)/(Ic/In) (4)

Where Ai is the calculated adjusted income; CLc may be considered the median cost of living value for the customer's state of residence; CLn is the median national cost of living; Ic is the monthly gross income for the customer (as provided in FIG. 1); and In is the median national gross income.

The cost of living numerator (CLc/CLn) may be considered a measure of a customer's specific “income strain” as compared to the national median. The income strain is an indicator of the amount of discretionary income a customer may have available to use for items and services beyond the necessities.

The income ratio denominator (Ic/In) is a measure of a customer's “income stress” (Is) as compared to the national median. A customer's income stress is an indicator that, in a specific region (e.g., the customer's home state), higher incomes demonstrate a greater earning ability. In other words, in regions where incomes are higher, people have more access to additional earnings, either through overtime or through longer regular work hours. Thus, in regions where a person has a greater earning potential, that person's ability to meet financial obligations is greater. On the other hand, in regions where the median income is lower than the national median, there tends to be reduced access to additional earned income, and thus a lesser ability to meet financial obligations.

Using a customer's adjusted income, as well as the calculated income stress, a permitted sale amount is determined, and a payment plan is calculated. Consider again the adjusted income Ai (equation 4). If equation (4) yields a solution of “1,” that solution indicates the customer is earning an income amount that is at least equal to the national median in purchasing power. If equation (4) yields a solution of less than “1,” that solution indicates the customer has a greater purchasing power than the national median. In other words, less of the customer's income is earmarked for normal expenditures, thus making it available for additional purchases. If the solution to equation (4) is greater than “1,” that solution indicates the customer is spending a higher percentage of his income on normal expenditures than the national median. Thus, an income stress value greater than 1 indicates that the customer has less money to spend on additional purchases.

After determining the adjusted income from equation (4), the percentage of returns-to-income value is calculated in order to gauge the propensity for a customer to default on the purchase. Looking again at FIG. 3, an indication of a higher income does not necessarily indicate a lower rate of return or a greater probability of repayment. In fact, examples FIGS. 2 and 3 indicate that people tend to live at a standard beyond their means at a rate that increases as the monthly income increases. Thus, the difficulty in managing debt seems to rise with the income level. Below a certain point in a monthly income rate, more of a customer's income appears to go to paying for necessities as opposed to discretionary spending. Looking back at FIG. 3, and as previously discussed, the intersection point 306 of lines 302 and 304 is the income level in this example where additional debt (i.e., a financed purchase) is most likely sustainable and will have the lowest rate of return.

Returning again to calculating a sale amount, the permitted sale amount may be calculated with equation (5) below:

PSa=(Mi/Ai)*(1−((((Mi/Is)*RRs)+RRy)/100)*(St/180)) (5)

Where PSa is the calculated permitted sales amount for a customer with a specific adjusted income; Mi is the customer's monthly income (provided in FIG. 1); Ai is the Adjusted Income calculated in equation (4); St is the number of days in the sales period; RRs is the percentage of returns value from FIG. 3 calculated from the customer's income; and RRy is the y-axis intercept depending on income level. For example, if the customer's income is greater than the x-value of point 306, then the y-axis intercept is calculated from solid line 304. If the customer's income is less than the x-value of point 306, then the y-axis intercept is calculated from dashed line 302.

The solution to equation (5) may change over time as economic factors change. Economic changes will impact the median incomes, both regionally and nationally, and will also affect the percentage of returns. The economic shifting, thus, will atomically find the least-like-to-experience-a-percentage of returns sales price. Merchants benefit from reduced percentage of returns, and customers benefit by reducing the chance of taking on a debt the customer cannot afford.

In one embodiment, the down payment for the purchase of the item is determined by the duration of the sales period. For example, if the sales period is 90 days, the down payment may be set at 20% of the determined purchase price. However, as the sales period increases, the amount required for the down payment will increase as a function of time. Thus, for a sales period of 180 days, the down payment may be set at 25% of the determined purchase price.

The remaining 80% of the purchase price is paid by the customer over the agreed upon sales period, with the amount of each payment due decreasing at a rate indicated from the willingness-to-pay slope in FIG. 5. By setting the payments corresponding to the willingness-to-pay slope, each payment during the sale period is progressively smaller, and thus the customer is more likely to complete payment for the item in full.

The payments are calculated at the time the sales period is initiated, and are displayed to the customer and the merchant in box 108 shown in FIG. 1. P

The above determinations can be calculated by financing software (such as ARC 90) executing on a computer system connected to a wired and/or wireless network. The payment calculator may be available to the merchant via an Internet based account, or a merchant may use a point-of-sale (POS) terminal running financing software. In one embodiment, payments may be made electronically by the customer, as by an electronic debit. In another embodiment, the customer may pay with a physical check.

While the specification has largely been described in terms of a merchant receiving a request from a customer to purchase an item that will be paid for over a sales period, in another embodiment, a third party financer may receive a request from merchant. In this embodiment, a merchant may collect the financial information from the customer and pass the financial information to a third party financer. The third party financer then approves the sale and calculates and appropriate payment plan.

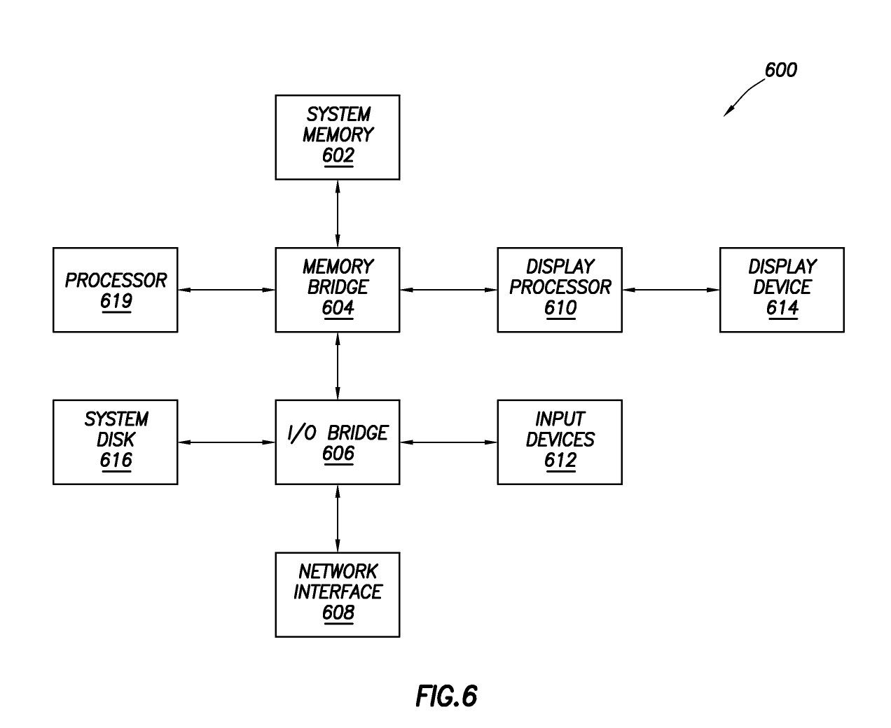

FIG. 6 shows, in block diagram form, a computer system 600, which is illustrative of a computer system upon which the various embodiments may be practiced. Computer system 600 comprises a processor 619 coupled to a system memory 602.

System memory 602, which is connected to processor 619 by way of memory bridge 604, functions as the working memory for the processor, and comprises a memory device or array of memory devices in which programs, instructions and data are stored. System memory 602 may comprise any suitable type of memory such as dynamic random access memory (DRAM) or any of the various types of DRAM devices such as synchronous DRAM (SDRAM), extended data output DRAM (EDODRAM), or Rambus DRAM (RDRAM). System memory 602 is an example of a non-transitory computer-readable medium storing programs and instructions, and other examples of a non-transitory computer-readable medium may include disk drives (e.g. hard drives or solid-state drives) and flash memory devices.

Memory bridge 604 is also connected to an input/output (I/O) bridge 606 via a bus or other communication path. The I/O bridge 606 controls many computer system functions, such as interfacing with various input devices 602, (e.g., a keyboard, mouse, game controller, serial ports, floppy drives, and disk drives). Further, I/O bridge 606 may be coupled to a network interface 608, which enables computer system 600 to communicate with other computer systems via an electronic communications network, and may include wired or wireless communication over local area networks, wide area networks, and/or the Internet. Other components, including universal serial bus (USB) ports or other communication port connections (e.g., RS323, RS485, FireWire) may also be supported by the I/O bridge 606.

The computer system 600 further comprises a display processor 610 which, in the example system of FIG. 6, is coupled to the memory bridge 604. In one embodiment, display processor 610 is a graphics subsystem that includes at least one graphics processing unit (GPU) and graphics memory. Display processor 610 couples to display device 614. The graphics processing unit (which may be part of display processor 610) may comprise an onboard processor, as well as onboard memory (not shown as to not unduly complicate the figure). The onboard processor may perform graphics processing, as commanded by CPU 620.

System disk 616 is coupled to I/O bridge 606 and may be configured to store content, applications, and data for use by processor 619. System disk 616 provides non-volatile storage for applications and data and may include fixed or removable hard disk drives, flash memory devices, and other magnetic, optical, or solid state storage devices. Computer system 600 may include, but is not limited to, personal desktop computers, servers, smartphones, web enabled television, tablet computers, or any other device having web browser software and a network interface.

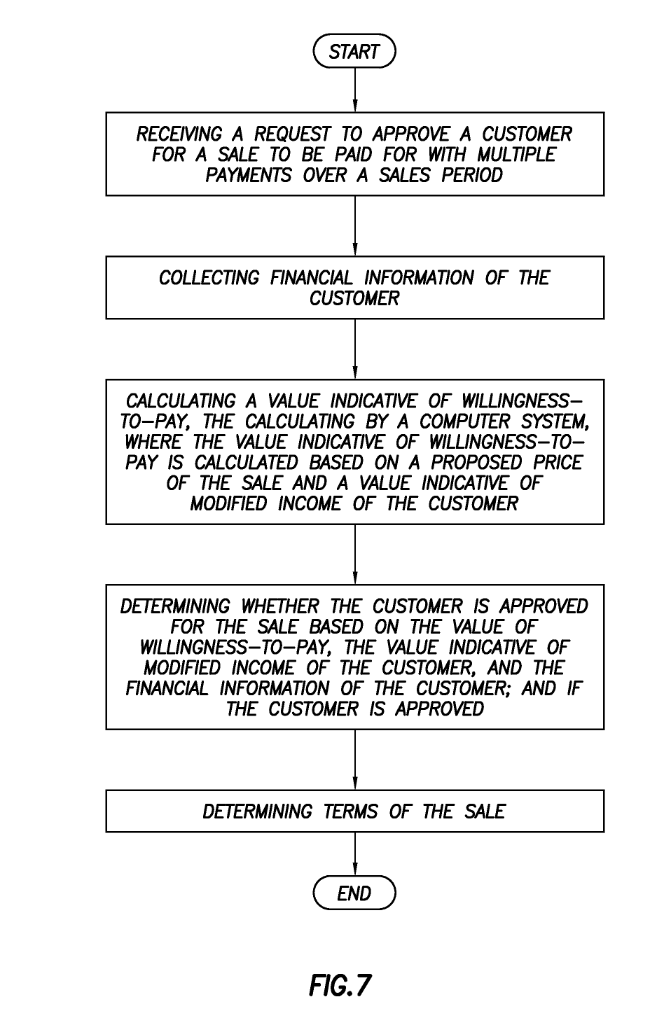

The method of approving a customer for a sale to be paid for over a set sales period will now be discussed in more detail. FIG. 7 shows a flow diagram depicting an overall method of approving a customer for a sale to be paid for over a set sales period. The method starts (block 700) and moves to receiving a request to approve a customer for a sale to be paid for with multiple payments over a sales period (block 702). The method then moves to collecting financial information of the customer (block 704); calculating a value indicative of willingness-to-pay, the calculating by a computer system, where the value indicative of willingness-to-pay is calculated based on a proposed price of the sale and a value indicative of modified income of the customer (block 706); and then determining whether the customer is approved for the sale based on the value indicative of willingness-to-pay, the value indicative of modified income of the customer, and the financial information of the customer (block 708). The method then moves to determining terms of the sale if the customer is approved. Thereafter, the method ends (block 710).

From the description provided herein, those skilled in the art are readily able to combine software created as described with appropriate general-purpose or special-purpose computer hardware to create a computer system and/or computer sub-components in accordance with the various embodiments, to create a computer system and/or computer sub-components for carrying out the methods of the various embodiments and/or to create a non-transitory computer-readable medium (i.e., not a carrier wave) that stores a software program to implement the method aspects of the various embodiments.

It is noted that while theoretically possible to perform some or all the calculations and analysis by a human using only pencil and paper, the time measurements for human-based performance of such tasks may range from man-days to man-years, if not more. Thus, this paragraph shall serve as support for any claim limitation now existing, or later added, setting forth that the period of time to perform any task described herein less than the time required to perform the task by hand, less than half the time to perform the task by hand, and less than one quarter of the time to perform the task by hand, where “by hand” shall refer to performing the work using exclusively pencil and paper.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A method comprising:
receiving a request to approve a customer for a sale to be paid for with multiple payments over a sales period;
collecting financial information of the customer;
calculating a value indicative of willingness-to-pay, the calculating by a computer system, where the value indicative of willingness-to-pay is calculated based on a proposed price of the sale and a value indicative of modified income of the customer; and then
determining whether the customer is approved for the sale based on the value indicative of willingness-to-pay, the value indicative of modified income of the customer, and the financial information of the customer; and if the customer is approved
determining terms of the sale.

2. The method of claim 1 further comprising calculating the value indicative of modified income of the customer, by:
dividing a state average cost of living, wherein the state is the customer's home state, by a national average cost of living, the dividing creates an adjusted cost of living;
dividing an indication of income of the customer by an average national income, the dividing creates an adjusted income; and then
dividing the adjusted cost of living by the adjusted income, the dividing creates the value indicative of the modified income.

3. The method of claim 1 wherein determining the terms of the sale further comprises determining the terms of the sale based on the value indicative of willingness-to-pay.

4. The method of claim 3 wherein determining the terms of the sale further comprises determining payments owed at the beginning of the sales period are of a higher amount and payments owed at the end of the sales period are of a lower amount.

5. The method of claim 1 wherein collecting financial information further comprises collecting at least one selected from the group consisting of: a pay stub; a bank statement; credit card statement; and balance statement.

6. The method of claim 1 wherein determining whether the customer is approved for the sale further comprises determining from the financial information being at least one selected from the group consisting of: a monthly beginning bank balance; a monthly ending bank balance; an average bank balance; income; an indication of a previously overdrawn account on a bank statement.

7. A system comprising:
a processor;
a memory coupled to the processor, the memory storing a program that, when executed by the processor, causes the processor to:
receive a request to approve a customer for a sale to be paid for with multiple payments over a sales period;
receive financial information of a customer regarding the sale;
calculate a value indicative of willingness-to-pay where the value indicative of willingness-to-pay is calculated based on a proposed price of a sale and a value indicative of modified income of a customer; and then
determine whether the customer is approved for the sale based on the value indicative of willingness-to-pay, the value indicative of modified income of the customer, and the financial information of the customer; and if the customer is approved
calculating a payment plan for the sale.

8. The system of claim 7 wherein the program further causes the processor to calculate the value indicative of modified income of the customer by causing the processor to:
divide a state average cost of living, wherein the state is the customer's home state, by a national average cost of living, the dividing creates an adjusted cost of living;
divide an indication of income of the customer by an average national income, the dividing creates an adjusted income; and then
divide the adjusted cost of living by the adjusted income, the dividing creates the value indicative of the modified income.

9. The system of claim 7 wherein the program further causes the processor to determine the terms of the sale further comprises determining the payment plan for the sale based on the value indicative of willingness-to-pay.

10. The system of claim 7 wherein when the processor determines, the program further causes the processor to determine payments owed at the beginning of the sales period are of a higher amount and payments owed at the end of the sales period are of a lower amount.

11. The system of claim 7 wherein when the processor receives financial information, the program further causes the processor to receive information represented in at least one selected from the group consisting of: a pay stub; a bank statement; credit card statement; and balance statement.

12. The system of claim 7 wherein when the processor determines whether the customer is approved for the sale, the program further causes the processor to determine from the financial information at least one selected from the group consisting of: a monthly beginning bank balance; a monthly ending bank balance; an average bank balance; income; an indication of a previously overdrawn account on a bank statement.

13. A non-transitory computer-readable medium storing a program that, when executed by a processor, causes the processor to:
receive a request to approve a customer for a sale to be paid for with multiple payments over a sales period;
receive financial information of a customer regarding the sale;
calculate a value indicative of willingness-to-pay where the value indicative of willingness-to-pay is calculated based on a proposed price of a sale and a value indicative of modified income of a customer; and then
determine whether the customer is approved for the sale based on the value indicative of willingness-to-pay, the value indicative of modified income of the customer, and the financial information of the customer; and if the customer is approved
calculating a payment plan for the sale.

14. The non-transitory computer-readable medium of claim 13 wherein the program further causes the processor to calculate the value indicative of modified income of the customer by causing the processor to:
divide a state average cost of living, wherein the state is the customer's home state, by a national average cost of living, the dividing creates an adjusted cost of living;
divide an indication of income of the customer by an average national income, the dividing creates an adjusted income; and then
divide the adjusted cost of living by the adjusted income, the dividing creates the value indicative of the modified income.

15. The non-transitory computer-readable medium of claim 13 wherein the program further causes the processor to determine the terms of the sale further comprises determining the payment plan for the sale based on the value indicative of willingness-to-pay.

16. The non-transitory computer-readable medium of claim 13 wherein when the processor determines, the program further causes the processor to determine payments owed at the beginning of the sales period are of a higher amount and payments owed at the end of the sales period are of a lower amount.

17. The non-transitory computer-readable medium of claim 13 wherein when the processor receives financial information, the program further causes the processor to receive information represented in at least one selected from the group consisting of: a pay stub; a bank statement; credit card statement; and balance statement.

18. The non-transitory computer-readable medium of claim 13 wherein when the processor determines whether the customer is approved for the sale, the program further causes the processor to determine from the financial information at least one selected from the group consisting of: a monthly beginning bank balance; a monthly ending bank balance; an average bank balance; income; an indication of a previously overdrawn account on a bank statement.
